(19) United States
(12) Patent Application Publication
(10) Pub. No.: US 2017/0270834 A1
(43) Pub. Date: Sep. 21, 2017

(54) SIMULATED CORK APPAREL TAG AND LABEL

(71) Applicant: AVERY DENNISON RETAIL INFORMATION SERVICES, LLC, Westborough, MA (US)

(72) Inventor: Barry VANDYK, New York, NY (US)

(21) Appl. No.: 15/465,015

(22) Filed: Mar. 21, 2017

Related U.S. Application Data
(60) Provisional application No. 62/310,872, filed on Mar. 21, 2016.

(51) Int. Cl. G09F 3/02; D03D 1/00; B41J 3/407; D03D 41/00; G09F 3/10; A41D 27/08; D03D 13/00

(52) U.S. Cl. CPC G09F 3/02; A41D 27/08; D03D 1/0011; D03D 13/004; D03D 41/00; G09F 3/10; B41J 3/4075; G09F 2003/023; G09F 2003/0282

(57) ABSTRACT

A tag, label or ticket simulating cork in appearance and method of manufacturing the tag for use in brand identification or embellishment on garments, apparel items and accessories. The invention utilizes Jacquard weaving and printing in order to create patterns which have the appearance of natural cork. The apparel tag, ticket or label can then be readily attached to the wearable article or apparel item by weaving, sewing, heat transfer, bonding or other suitable means.

### CROSS-REFERENCE TO RELATED APPLICATION

The present invention claims priority to U.S. Provisional Application No. 62/310,872 filed on Mar. 21, 2016, which is incorporated herein by reference in its entirety.

### BACKGROUND

The present invention relates generally to apparel tags and labels that mimic cork in appearance. More particularly, the present disclosure relates to the manufacture of simulated cork apparel tags, tickets and labels for use in brand identification on garments, apparel items and accessories. The invention utilizes weaving and printing techniques to create tags, tickets and labels with patterns having the appearance of natural cork. The apparel tags, tickets and labels can then be readily attached to the apparel item or garment.

Jacquard weaving has been used to create complex woven designs, which may include repeating designs, such as those which may be seen in upholstered or tapestry type of fabrics. Exemplary fabrics made by Jacquard weaving include for instance brocade, damask, and brocatelle.

Developing sustainable alternatives is a significant objective in providing renewable products which reduce the environmental impact in creating branding products that are used to enhance, elevate and accelerate the acceptance and recognition of branded products, particularly in the area of apparel, fashion and accessories associated therewith. By creating simulated cork products such as through the present invention, cork trees are not harvested for their bark allowing the trees to grow, reduce the threat to the environment and creating a more sustainable solution without sacrificing the look and feel of the desired product.

Various materials can be used in the formation of the products described in the present application to create a tag or label that mimics cork without the need to harvest cork trees. Thus, there exists a need for a tag, ticket or label that simulates natural cork in appearance. The present invention discloses a tag, ticket or label resembling cork that is attachable to a garment and a process for creating the tags. The invention may use a variety of materials, that when combined, resemble natural cork.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a tag, ticket or label woven in a pattern that resembles natural cork which is attachable to apparel. The tag comprises a front side with indicia such as branding information, logos, images, and care information printed onto the front side. The tag further comprises a back side that is attachable to the apparel, such as by sewing, adhesive, ultrasonic welding or other bonding technique. The pattern resembling cork is created by combining at least two distinct yarns of different colors chosen to mimic cork once combined.

In a preferred embodiment, a method of generating a plurality of woven labels, tickets or tags for use with a wearable article or apparel is described. The method employs a Jacquard loom to weave the tags with a simulated cork pattern. An automated system may be used to create a design and to select a plurality of yarns for the cork pattern. The plurality of yarns are then woven together to form a stock material which can then be cut into the desired tag, ticket or label. A plurality of indicia may be printed on to a front face of the stock material to indicate branding information, logos, images, and care information, or to improve the simulated cork design. Then the stock material is cut into individual tags, tickets or labels which are attachable to wearable garments or other apparel items or accessories.

It should be understood that reference to tag can be used interchangeably to reference labels, tickets or tags or other branding related embellishments that an apparel company, retailer or other brand owner may use to identify or market their product to a consumer.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of an apparel tag in accordance with the disclosed architecture.

FIG. 2 illustrates a perspective view of the apparel tag affixed to an item of apparel in accordance with the disclosed architecture.

FIG. 3 illustrates a perspective view of the apparel tag in accordance with the disclosed architecture.

FIG. 4 illustrates a block diagram of a method of producing an apparel tag in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

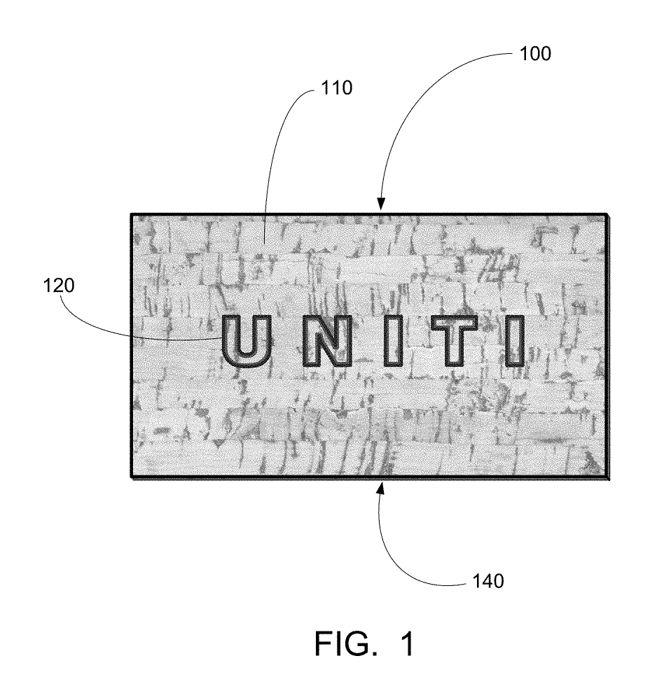

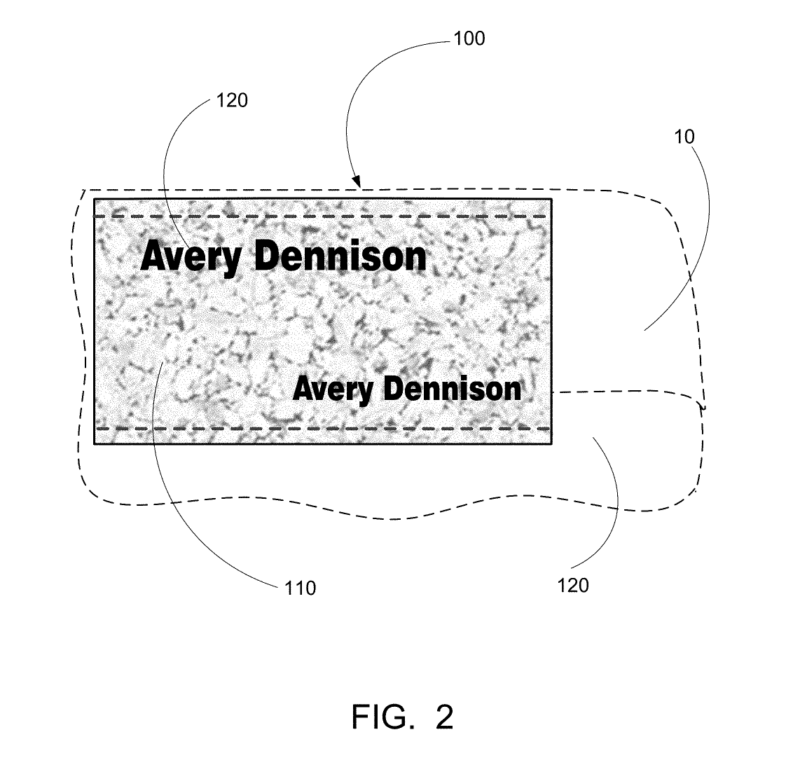

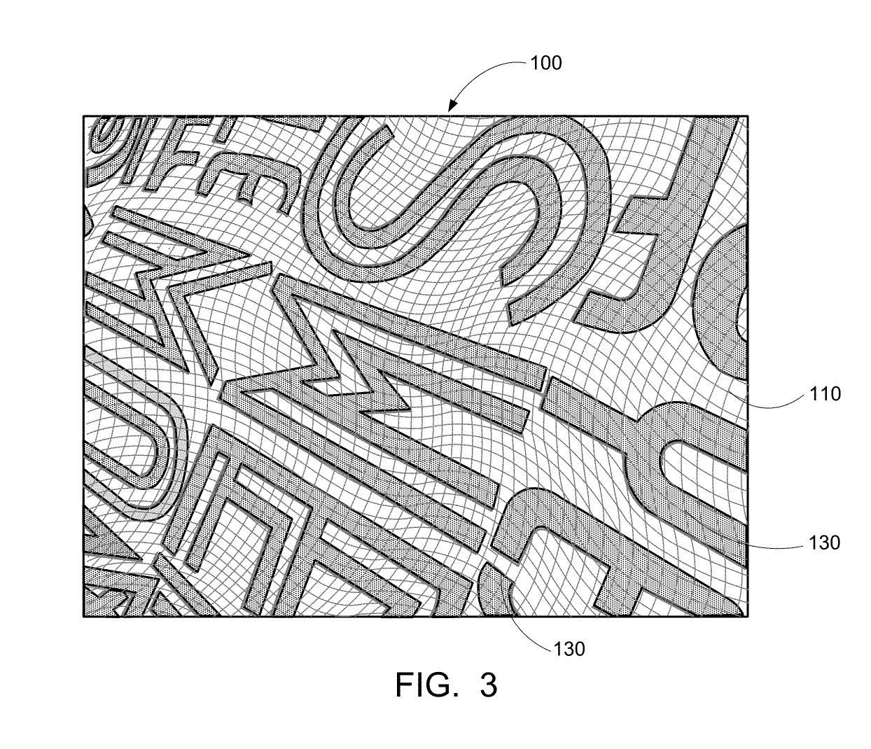

Referring initially to the drawings, FIGS. 1-3 illustrate a tag 100 woven in a pattern that simulates cork in accordance with the present invention. The tag 100 is woven from a plurality of yarn having a plurality of colors typically using a Jacquard loom. The colors may be any colors combinable that can mimic the appearance of cork once combined. For example, different shades of brown, black, gray and white could be combined to simulate cork and different species of cork tree if a brand owner or retailer desires to link the apparel items to a specific region where cork labels may be obtained. The pattern is generated as the yarn is woven together. The tag 100 is then typically affixed to a piece of apparel such as a wearable article 10. The tag 100 is typically constructed in a Damask structure to better simulate cork.

The tag 100 comprises a front side 110 and a back side 140. The front side 110 comprises at least one indicia 120. The indicia 120 is typically printed onto the front side 110 by flexographic printing, ink jet printing, electrostatic printing, dye sublimation, and the like, or by any suitable technique known to one of skill in the art for producing indicia on a surface. The at least one indicia 120 may comprise brands, images, logos, letters, numbers, symbols, images, themes, care instructions, or any similar representation that would be desirable to be printed on a tag or label. The front side 110 may further comprise a textural component 130 woven into the tag 100 comprising textural patterns, repeating background patterns, characters, and the like.

The back side 140 is securable to the wearable article 10 by sewing, weaving, adhesive, mechanical fastener, or by any method of attaching a tag to a garment. The back side 140 may comprise a thermally sensitive adhesive (not shown) or a heat seal backing that is removable during the adhering process.

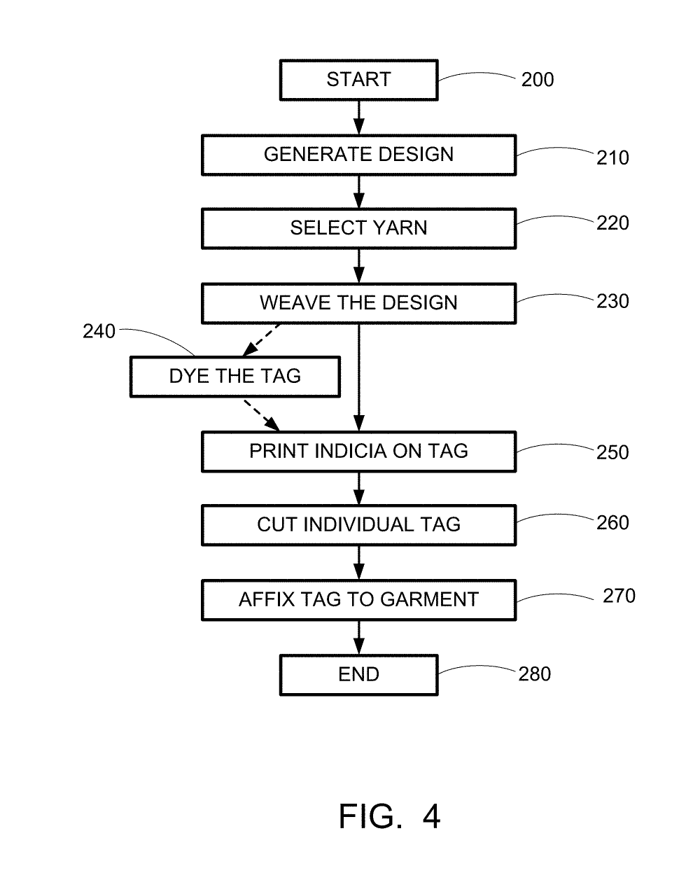

Having described a preferred structure of the tag 100, a method of producing a plurality of woven tags 100 with a simulated cork pattern as illustrated in FIG. 4 will now be described. The method starts at 100, typically with a request for a product, such as from an apparel, garment factory, or brand owner. A designer checks an available database for design ideas and either selects one or more existing designs or creates a new design as needed. The database may include design components where the appearance of the cork design is modifiable by changing the colors of the dark or light fibers during manufacture to add variability into the cork design so that each individual tag could vary from the next tag, or so that a particular pattern could be assignable to a specific customer. Additionally, designs may mimic different types of cork by taxonomic classification.

The design simulating cork is then generated at step 210. A plurality of yarn is selected at 220 that are appropriate for the selected design. The plurality of yarn may be any color or material, such as but not limited to synthetic material, including synthetic yarns such as polyester based yarns in any sort of color (e.g. white, black, or dyed yarns) as well as virgin or recycled PET natural fibers, recycled material, or any combination thereof. The plurality of yarns is then woven together at 230 with a Jacquard loom to form an individual tag or a tag stock material. The plurality of yarn is separated into a warp component (not shown) and a weft component (not shown) for weaving on the loom.

Once woven, at 250, the front side 110 of the tag 100 is printed with the plurality of indicia 120, such as but not limited to brand or trademark information, design elements, textural features, informational details such as the origin materials used in the tag 100 or care and handling instructional for the attached garment 10, and the like. At 260, the tag stock material may be cut or sectioned into the plurality of individual woven tags 100. Cutting may be accomplished by laser cutting, ultrasonic, mechanical die, scissors, blades, or by any other suitable mechanism for separating the plurality of individual tags from the tag stock material.

At 270, each of the plurality of individual tags 100 is then affixed or attached to the wearable article, garment, apparel item, accessory, or the like. The plurality of individual tags 100 may be affixed by traditional weaving, sewing, creating simulated stitching while affixing the tag with heat and/or pressure, adhesive, mechanical fastener, ultrasonic bonding and the like, or by any other method of affixing a tag to a surface as is known to one of skill in the industry. The method then ends at 280.

One exemplary method for producing the tag 100 utilizes a Jacquard loom to produce the tag 100 using 144 or 288 denier warp density, in 16, 12, 5, 5, or other weft shafts. This forms a Damask structure having a density range of low to medium to high, with pick insertions ranging from 2.0 to 12.0 or higher per millimeter. The plurality of indicia 120 may be applied using a Single, Double, or Triple Shuttle Logo/Lettering design technique and other special woven texture(s) may or may not be used as desired.

In producing the plurality of indicia 120 on the tag 100 or the tag stock material, dye sublimation, also known as sublistatic heat transfer can be used to create the indicia, or to enhance the cork pattern design on the tag 100. This additional step, as illustrated in step 240, is optional in the method. The tag 100 may then be applied to the wearable article 10 through the optional use of a non-woven heat seal backing(not shown) which would be removed from the back side 140 of the tag 100 prior to affixing the tag 100 to the wearable article 10. Furthermore, the tag 100 may be laser cut to customize the tag 100 in size or shape, including irregular shapes depending on the particular design that would be desirable. The shape of the design may include and alphanumeric, geometric, or fanciful shape as desired.

In another exemplary method for producing a label 100, the simulated cork pattern is selected along with a warp component comprising yarn with a first color and warp density, and a weft component comprising yarn of a second color and weft density which are woven into a Damask structure. Then a design simulating cork is applied to the label 100 using a dye sublimation process and a plurality of indicia 120 is printed on the label 100. The label 100 is then attached to a piece of apparel 10.

The method uses 144 Damask, with thick heavy Denier 150d White ground weft. A Brown Lettering weft is applied in a double shuttle using the highest possible denier. Both shuttles of the Brown Lettering wefts are woven the entire length of the label 100 on the backside 140 with a low pick rate so that the highest deniers may be used. The cork background is applied with the dye sublimation technique, and a 2× thick paper backing is applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tag woven in a pattern simulating cork that is securable to a wearable article, comprising:
A front side comprising at least one indicia;
a back side securable to the wearable article; and
wherein the pattern simulating cork is generated by weaving together a plurality of yarn comprising at least two colors together.

2. The tag of claim 1, wherein the tag further comprises a plurality of woven textural patterns.

3. The tag of claim 1, wherein the tag is sewn on to the wearable garment.

4. The tag of claim 1, wherein the back side of the tag comprises a thermally sensitive adhesive for securing the tag to the wearable garment.

5. The tag of claim 1, wherein the at least one indicia is printed on the tag by flexographic printing, ink jet printing, electrostatic printing, or dye sublimation.

6. The tag of claim 1, wherein the at least one indicia comprises: a brand, an image, a logo, a theme, or a set of care instructions.

7. A method of producing a plurality of woven tags with a simulated cork pattern, comprising the steps of:
generating a design simulating cork;
selecting a plurality of yarn for weaving the design;
weaving the plurality of yarn into a tag stock material;
printing a plurality of indicia on a front face of the tag stock material;
cutting the tag stock material into a plurality of individual woven tags; and
attaching each individual woven tag to a wearable garment.

8. The method of claim 7, further comprising the step of printing a design simulating cork on the tag stock material using a dye sublimation process.

9. The method of claim 7, wherein each individual woven tag comprises a Damask structure.

10. The method of claim 9, wherein the tag stock material has a warp density of 144 or 288 denier.

11. The method of claim 7, wherein the plurality of yarn comprise a warp component and a weft component.

12. The method of claim 11, wherein the weft component is woven using approximately between 2 and 12 pick insertions per millimeter.

13. The method of claim 7, wherein the simulated cork pattern mimics taxonomic classifications of cork.

14. The method of claim 7, wherein a Jacquard loom is used to form the tag stock material.

15. The method of claim 14, wherein the tag stock material comprises a plurality of woven textural patterns.

16. The method of claim 7, wherein the plurality of indicia is printed on the tag by flexographic printing, ink jet printing, electrostatic printing, or dye sublimation.

17. The method of claim 7, wherein the plurality of individual woven tags are attached to the wearable garment using an adhesive.

18. The method of claim 7, wherein the plurality of individual woven tag are attached to the wearable garment using a heat and pressure technique.

19. The method of claim 7, wherein the plurality of individual woven tags each comprise a non-woven heat seal backing.

20. A method of producing a woven label with a simulated cork pattern, comprising the steps of:
selecting a simulated cork pattern;
selecting a warp component comprising a first color and a warp density;
selecting a weft component comprising a second color and a weft density;
weaving the warp component and the weft component into a Damask structure;
printing a design simulating cork on the woven label using a dye sublimation process;
printing a plurality of indicia on a front face of the woven label; and
attaching the woven label to a piece of apparel.
